(19) United States
(12) Patent Application Publication
(10) Pub. No.: US 2003/0061951 A1
(43) Pub. Date: Apr. 3, 2003

(54) Shoe fabric having a concealed pattern and its fabrication method

(76) Inventor: Tony Tseng, Chang Hua Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/969,046

(22) Filed: Oct. 1, 2001

(51) Int. Cl. B41L 9/10; B41F 1/00

(52) U.S. Cl. 101/132

(57) ABSTRACT

A method of fabricating a shoe fabric having a concealed pattern, including the step of weaving prepared warp yarns and weft yarns into a woven fabric, and the step of using a hot imprinting apparatus to print the woven fabric into a finished shoe fabric having printed patterned flat surface portions and non-patterned surface portions on a front side thereof. The finished shoe fabric has printed patterned flat surface portions that reflect light and non-patterned surface portions that refract light, such that the pattern in the printed patterned flat surface portions is seen when viewed perpendicularly from the front side, or become invisible when viewed from an oblique angle.

### BACKGROUND OF THE INVENTION

The present invention relates to a shoe fabric, which shoes a pattern in different forms when viewed from different angles. The invention relates also to the fabrication of the shoe fabric.

When making sports shoes, trademarks, logos, and other patterns may be formed on the shoe upper by high frequency heat sealing or screen-printing. These signs and patterns are less attractive. Further, these signs and patterns tend to be rubbed away with the use of the shoes.

### SUMMARY OF THE INVENTION

The present invention has been accomplished under the circumstances in view. It is one object of the present invention to provide a shoe fabric, which shows a pattern in different forms when viewed from different angles. It is another object of the present invention to provide a patterned shoe fabric, which has a pattern imprinted on it so that the pattern does not wear away quickly with the use of the shoe. According to the present invention, the method of fabricating a shoe fabric having a concealed pattern comprises the step of weaving elastic warp yarns and elastic weft into a woven fabric, and the step of using an imprinting apparatus to imprint the woven fabric under a predetermined imprinting temperature and imprinting pressure into a finished shoe fabric having imprinted patterned light-reflecting flat surface portions, and non-patterned light-refracting surface portions on a front side thereof. The finished shoe fabric has printed patterned flat surface portions that reflect light and non-patterned surface portions that refract light, such that the pattern in the printed patterned flat surface portions is seen when viewed perpendicularly from the front side, or become invisible when viewed from an oblique angle.

### BRIEF DESCRIPTION OF THE DRAWINGS

FIG. 1 illustrates a woven fabric fed from a fabric feeding mechanism through a plate cylinder and impression cylinder set according to the present invention.

FIG. 2 illustrates the structure of an elastic yarn for the fabrication of a shoe fabric having a concealed pattern according to the present invention.

FIG. 3 illustrates a semi-finished woven fabric refracted light toward different directions according to the present invention.

FIG. 4 illustrates the patterned flat surface portions of a finished shoe fabric reflected light toward a particular angle according to the present invention.

FIG. 5 shows the pattern of the shoe fabric presented in different forms when viewed from different angles.

### DETAILED DESCRIPTION OF THE PREFERRED EMBODIMENT

Referring to FIGS. from 1 through 5, the method of fabricating a shoe fabric having a concealed pattern in accordance with the present invention comprises the steps of:

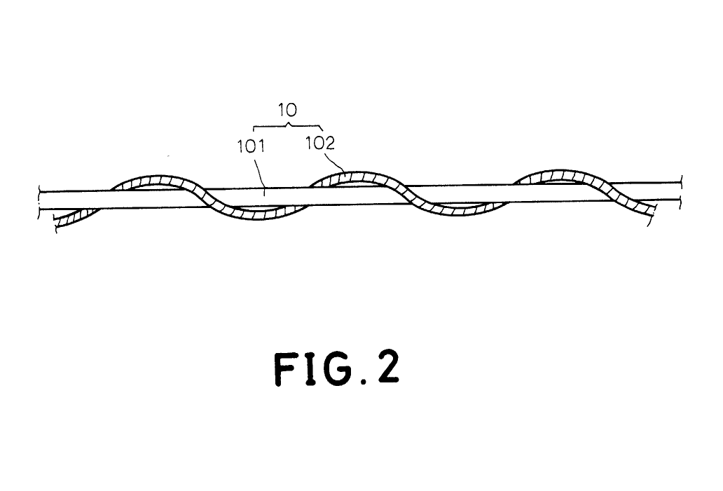

(a) preparing warp yarns 11 and weft yarns 12 for weaving, where the warp yarns 11 and the weft yarns 12 are elastic yarns 10 (see FIG. 2) each comprising at least one strand of elastic core fibers (for example, rubber or spandex fibers) 101, and at least one strand of cover fibers (for example, Tetoron yarn, raw silk, or synthetic fibers) 102 spirally wound round the at least one strand of elastic core fibers 101;

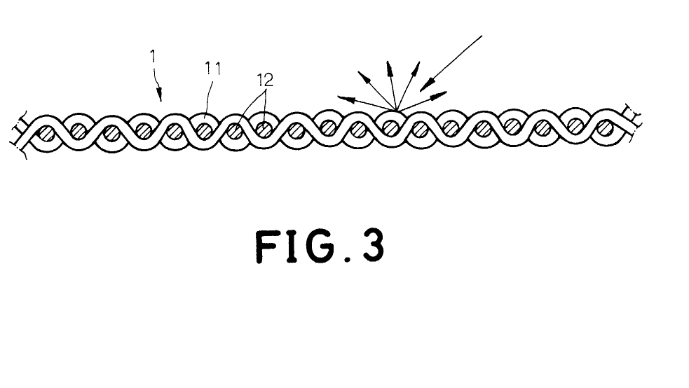

(b) using the prepared warp yarns 11 and weft yarns 12 to weave a woven fabric 1 (see FIG. 3) that refracts light toward different directions, by means of three-up one-down shuttle weaving, one-up one-down plain weaving, or any suitable equivalent weaving method;

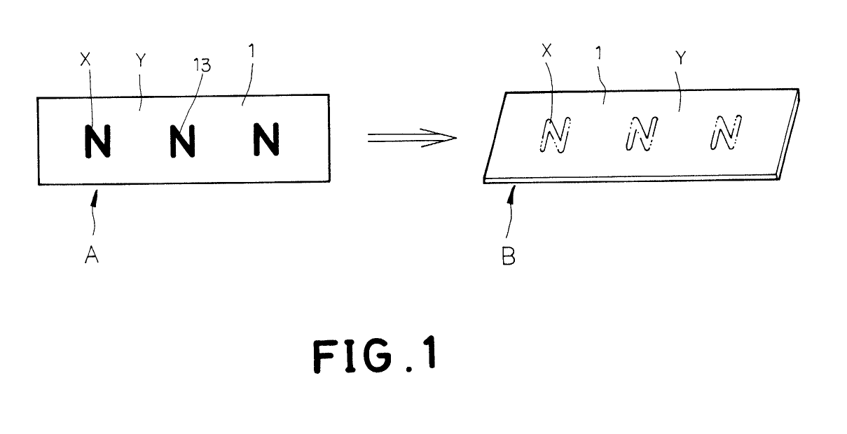

(c) preparing a hot imprinting apparatus, for example, a plate cylinder and impression cylinder set 2 subject to a predetermined pattern (see FIG. 1), and then heating the plate cylinder and impression cylinder set 2 to a predetermined temperature level, for example, 100° C.˜300° C.;

(d) using a fabric feeding mechanism 3 to feed the woven fabric 1 through the plate cylinder and impression cylinder set 2; and

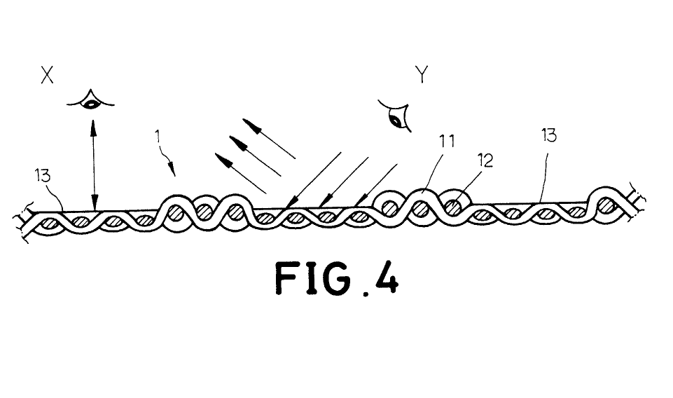

(e) Rotating the plate cylinder and impression cylinder set 2 during feeding of the woven fabric 1 and imparting a pressure, for example, 1˜7 bar through the plate cylinder and impression cylinder set 2 to the woven fabric 1 passing through the plate cylinder and impression cylinder set 2, causing the woven fabric 1 to have patterned flat surface portions 13 spaced on the surface thereof that reflect light like the functioning of a mirror (see FIG. 4).

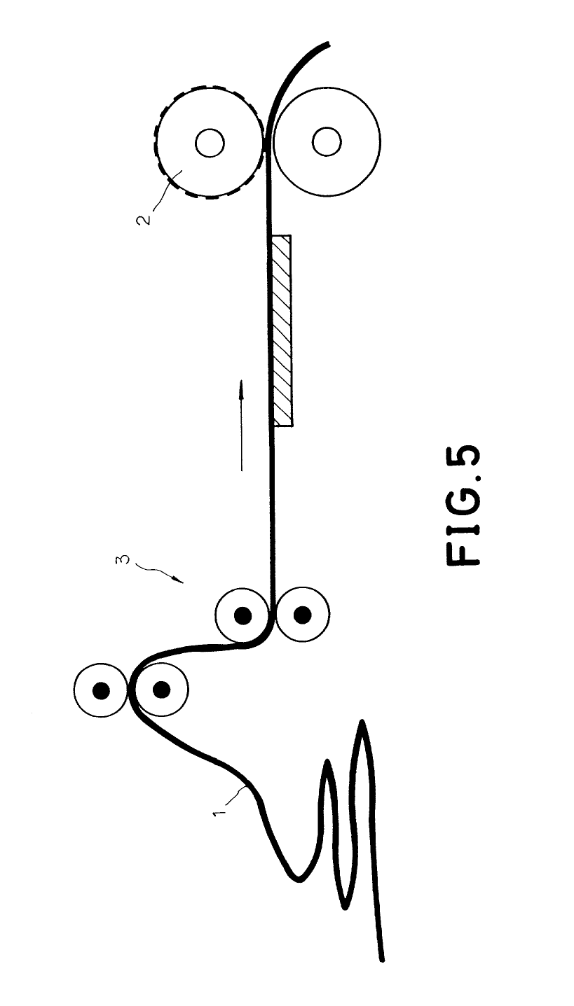

After the pressing of the aforesaid plate cylinder and impression cylinder set, the desired patterned shoe fabric is obtained. When illuminated, the patterned flat surface portions 13 reflect light from the light source toward a particular angle, and the other area of the surface of the patterned shoe fabric refracts light from the light source toward different directions, and therefore the pattern in the patterned flat surface portions 13 is shown in a different form when viewed from a different angle (see FIG. 5). FIG. 5A shows the pattern viewed from the top side (The direction X shown in FIG. 4). FIG. 5B shows the pattern viewed obliquely (the direction Y shown in FIG. 4). When viewing the shoe fabric obliquely, the pattern is not clearly seen (see FIG. 5A).

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A method of fabricating a shoe fabric having a concealed pattern, comprising the step of preparing warp yarns and weft yarns and then using prepared warp yarns and weft yarns to weave a woven fabric, and the step of using an imprinting apparatus to imprint said woven fabric under a predetermined imprinting temperature and imprinting pressure into a finished shoe fabric having imprinted patterned flat surface portions and non-patterned surface portions on a front side thereof.

2. The method as claimed in claim 1 wherein said warp yarns and said weft yarns are woven into said woven fabric by three-up one-down shuttle weaving.

3. The method as claimed in claim 1 wherein said warp yarns and said weft yarns are woven into said woven fabric by one-up one-down plain weaving.

4. The method as claimed in claim 1 wherein said imprinting apparatus is comprised of a plate cylinder and impression cylinder set.

5. The method as claimed in claim 1 wherein said imprinting temperature is within about 100° C.˜300° C.

6. The method as claimed in claim 1 wherein said imprinting pressure is within about 1˜7 bar.

7. The method as claimed in claim 1 further comprising the step of using a fabric feeding mechanism to fed said woven fabric through said imprinting apparatus for imprinting.

8. The method as claimed in claim 1 wherein said imprinting apparatus is operated to print said woven fabric at different locations so that the finished shoe fabric has non-printed surface portions that refract light, and printed patterned flat surface portions.

9. The method as claimed in claim 1 wherein said patterned flat surface portions reflect light such that a pattern is seen in said patterned flat surface portions when viewed perpendicularly from the front side of the finished shoe fabric.

10. The method as claimed in claim 9 wherein said patterned flat surface portions reflect light such that the pattern in said patterned flat surface portions is invisible when viewed obliquely from the front side of the finished shoe fabric.

11. The method as claimed in claim 1 wherein said warp yarns and said weft yarns are elastic yarns.

12. The method as claimed in claim 11 wherein said elastic yarns each comprise at least one strand of elastic core fibers and at least one strand of cover fibers spirally wound round said at least one strand of elastic core fibers.

13. The method as claimed in claim 12 wherein said elastic core fibers are spandex.

14. The method as claimed in claim 12 wherein said cover fibers are Tetoron yarn.

15. The method as claimed in claim 12 wherein said cover fibers are raw silk.

16. The method as claimed in claim 12 wherein said cover fibers are synthetic fibers.

17. A patterned shoe fabric comprising a fabric body having on a front side thereof patterned flat surface portions that reflect light and non-patterned surface portions that refract light, said fabric body comprising warp yarns and weft yarns cross-woven together.

18. The patterned shoe fabric as claimed in claim 17 wherein said warp yarns and said weft yarns are woven into said fabric body by three-up one-down shuttle weaving.

19. The patterned shoe fabric as claimed in claim 17 wherein said warp yarns and said weft yarns are woven into said fabric body by one-up one-down plain weaving.

20. The patterned shoe fabric as claimed in claim 17 wherein said patterned flat surface portions are formed by means of the imprinting of a hot imprinting apparatus under a predetermined imprinting temperature and a predetermined imprinting pressure.

21. The patterned shoe fabric as claimed in claim 20 wherein said hot imprinting apparatus is comprised of a plate cylinder and impression cylinder set.

22. The patterned shoe fabric as claimed in claim 20 wherein said imprinting temperature is within about 100° C.˜300° C.

23. The patterned shoe fabric as claimed in claim 20 wherein said imprinting pressure is within about 1˜7 bar.

24. The patterned shoe fabric as claimed in claim 17 wherein said patterned flat surface portions reflect light such that a pattern is seen in said patterned flat surface portions when viewed perpendicularly from the front side of the finished shoe fabric.

25. The patterned shoe fabric as claimed in claim 24 wherein said patterned flat surface portions reflect light such that the pattern in said patterned flat surface portions is invisible when viewed obliquely from the front side of the finished shoe fabric.

26. The patterned shoe fabric as claimed in claim 17 wherein said warp yarns and said weft yarns are elastic yarns.

27. The patterned shoe fabric as claimed in claim 17 wherein said elastic yarns each comprise at least one strand of elastic core fibers and at least one strand of cover fibers spirally wound round said at least one strand of elastic core fibers.

28. The patterned shoe fabric as claimed in claim 27 wherein said elastic core fibers are spandex.

29. The patterned shoe fabric as claimed in claim 27 wherein said cover fibers are Tetoron yarn.

30. The patterned shoe fabric as claimed in claim 27 wherein said cover fibers are raw silk.

31. The patterned shoe fabric as claimed in claim 27 wherein said cover fibers are synthetic fibers.
